(19) United States
(12) Patent Application Publication
(10) Pub. No.: US 2025/0354603 A1
(43) Pub. Date: Nov. 20, 2025

(54) PLANETARY ROLLER SCREW ARRANGEMENT

(71) Applicant: Schaeffler Technologies AG & Co. KG, Herzogenaurach (DE)

(72) Inventor: Craig Hooker, Indian Land, SC (US)

(73) Assignee: Schaeffler Technologies AG & Co. KG, Herzogenaurach (DE)

(21) Appl. No.: 19/206,042

(22) Filed: May 13, 2025

Related U.S. Application Data
(60) Provisional application No. 63/648,720, filed on May 17, 2024.

(51) Int. Cl. F16H 25/22

(52) U.S. Cl. CPC F16H 25/2252; F16H 2025/228

(57) ABSTRACT

A planetary roller screw arrangement is provided includes a threaded nut, a threaded spindle, and a plurality of threaded planets. The threaded nut has a first longitudinal length and a first threaded portion that spans a second longitudinal length. The threaded spindle has a second threaded portion that spans a third longitudinal length. The plurality of threaded planets are arranged radially between the threaded spindle and the threaded nut and have a third threaded portion configured to be threadedly engaged with the first threaded portion, the third threaded portion spanning a fourth longitudinal length. The fourth longitudinal length is greater than the third longitudinal length.

### CROSS-REFERENCE TO RELATED APPLICATIONS

This application claims priority to U.S. Provisional Application 63/648,720 filed May 17, 2024, the entire disclosure of which is incorporated by reference herein.

### TECHNICAL FIELD

This disclosure is generally related to a planetary roller screw arrangement.

### BACKGROUND

Planetary roller screws are known and can be utilized translate rotary motion to linear motion. Planetary roller screws can generate high axial forces with relatively low drive torques and offer high reliability and repeatability.

### SUMMARY

An example embodiment of a planetary roller screw arrangement is provided that converts rotary motion to linear motion. The planetary roller screw arrangement includes a threaded nut, a threaded spindle, and a plurality of threaded planets. The threaded nut has a first longitudinal length and a first threaded portion. A first end and a second end of the first threaded portion define a second longitudinal length. The threaded spindle has a second threaded portion. A first end and a second end of the second threaded portion define a third longitudinal length. The threaded spindle is disposed within the threaded nut. The plurality of threaded planets, which have a third threaded portion threadedly engaged with the first threaded portion, are arranged radially between the threaded spindle and the threaded nut. A first end of the third threaded portion and a second end of the third threaded portion define a fourth longitudinal length. In an example embodiment, the fourth longitudinal length is greater than the third longitudinal length. Rotation of one of the either the threaded nut or the threaded spindle causes linear displacement of a remaining one of the threaded nut or the threaded spindle via the first threaded portion, the second threaded portion, and the third threaded portion.

In an example embodiment, the fourth longitudinal length is greater than the second longitudinal length.

In an example embodiment, a ratio of the fourth longitudinal length to the third longitudinal length is at least 1.5.

In an example embodiment, the first longitudinal length is greater than the third longitudinal length.

In an example embodiment, the third threaded portion threadedly engages the second threaded portion.

In an example embodiment, a first end of the threaded spindle is coupled to a first push rod, and a second end of the threaded spindle is coupled to a second push rod. In a further aspect, at least one of the first or second push rods is configured as an abutment that limits radial deflection of the plurality of threaded planets.

In an example embodiment, the threaded spindle is configured to move to a linear position where the third longitudinal length does not overlap with the second longitudinal length in an axial direction.

In an example embodiment, the planetary roller screw arrangement further includes a first internal gear arranged at a first end of the threaded nut and a second internal gear arranged at a second end of the threaded nut, and the first and second internal gears have internal teeth that engage with the plurality of planets. In a further aspect, each one of the plurality of planets includes a first planet gear arranged at a first end, and a second planet gear arranged at a second end, and the first and second gears respectively engage the first and second internal gears.

In an example embodiment, the planetary roller screw arrangement further includes a first planet ring arranged at a first end of the threaded nut, and a second planet ring arranged at a second end of the threaded nut. The first planet ring rotatably supports a first end of each one of the planets. The second planet ring rotatably supports a second end of each one of the planets. The first and second planet rings rotate relative to the threaded nut.

An example embodiment of a planetary roller screw arrangement is provided that includes a threaded nut, a threaded spindle, and a plurality of threaded planets. A first planet ring is fixed to a first end of the threaded nut and a second planet ring is fixed to a second end of the threaded nut. The arrangement of the first and second planet rings can define a first longitudinal length of the threaded nut. The threaded nut includes a bore that has a first threaded portion that spans a second longitudinal length. The threaded spindle has a second threaded portion that spans a third longitudinal length. The plurality of threaded planets has a third threaded portion that threadedly engages with the first threaded portion, and the third threaded portion spans a fourth longitudinal length. The first longitudinal length is greater than the third longitudinal length. In a further aspect, the fourth longitudinal length is greater than the third longitudinal length.

In an example embodiment, the first end of the plurality of threaded planets defines a first axial travel stop for the threaded spindle, and the second end of the plurality of threaded planets defines a second axial travel stop for the threaded spindle.

In an example embodiment, the threaded nut includes a first internal gear arranged at a first end, and a second internal gear arranged at a second end. The first internal gear engages a first gear arranged on each one of the plurality of threaded planets. The second internal gear engages a second gear arranged on each one of the plurality of threaded planets.

In an example embodiment, the bore of the threaded nut includes a first threaded portion arranged at a first end and a second non-threaded portion arranged between the first threaded portion and a second end. A first end of the first threaded portion and a second end of the first threaded portion defines a first longitudinal length, and a first end of the second non-threaded portion and a second end of the second non-threaded portion defines a second longitudinal length. The plurality of threaded planets has a first planet end rotatably supported by the first end of the bore, and a second planet end rotatably supported by the second end of the bore. The plurality of threaded planets further includes a second threaded portion that is configured to: i) threadedly engage the first threaded portion, and ii) extend across the second non-threaded portion in an axial direction toward the second planet end. The second threaded portion can extend continuously with a constant outer diameter. The threaded spindle has a third threaded portion configured to threadedly engage both the first threaded portion and the plurality of threaded planets so as to move the threaded spindle linearly relative to the plurality of threaded planets. A first end of the third threaded portion and a second end of the third threaded portion define a third longitudinal length that is less than the second longitudinal length. In a further aspect, the second longitudinal length is greater than the first longitudinal length.

### BRIEF DESCRIPTION OF THE DRAWINGS

FIG. 1 shows a cross-sectional view of an example embodiment of a planetary roller screw arrangement.

FIG. 2 shows a perspective view of a prior art planetary roller screw arrangement.

FIG. 3A shows a perspective view of a prior art planetary roller screw arrangement.

FIG. 3B shows an exploded perspective view of the planetary roller screw arrangement of FIG. 3A.

FIG. 4A shows a front view of a first helical thread pair.

FIG. 4B shows a front view of a second helical thread pair.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

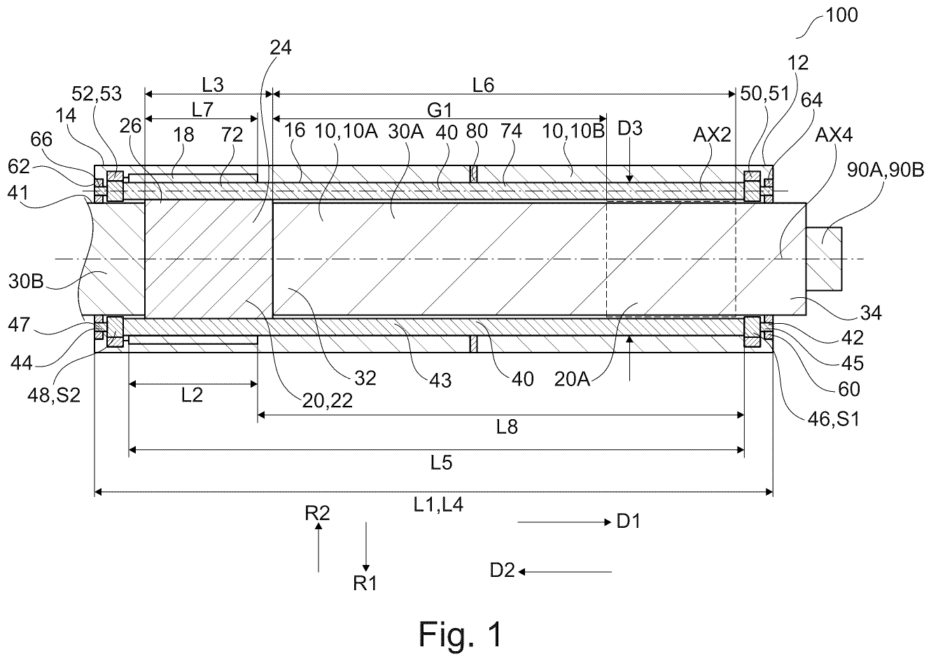

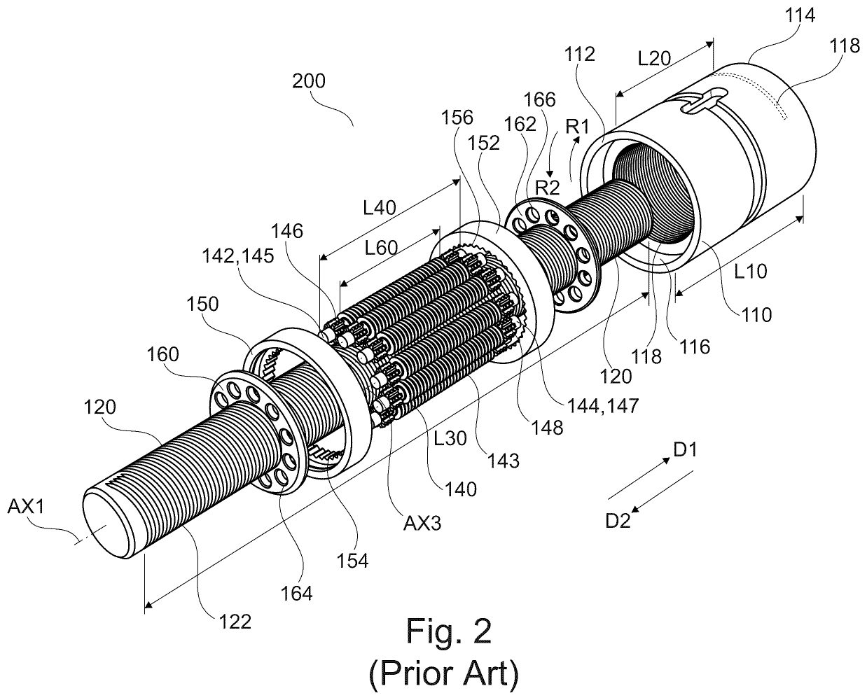

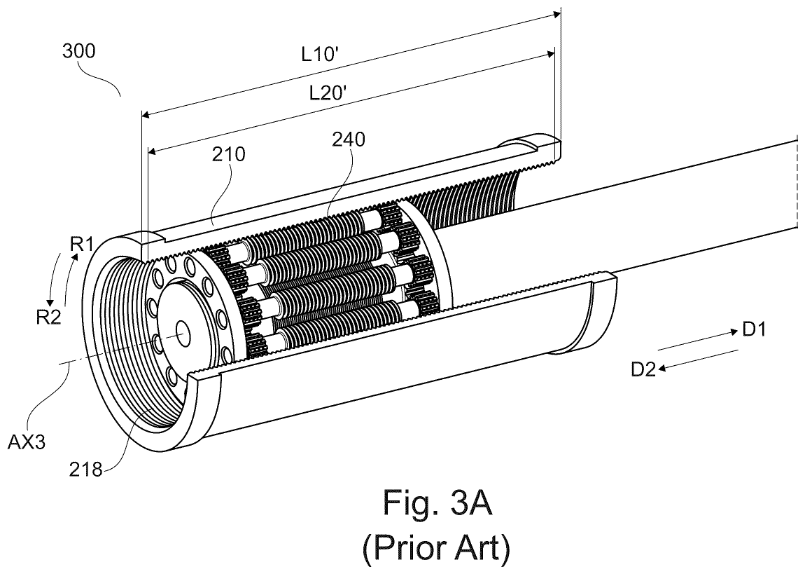

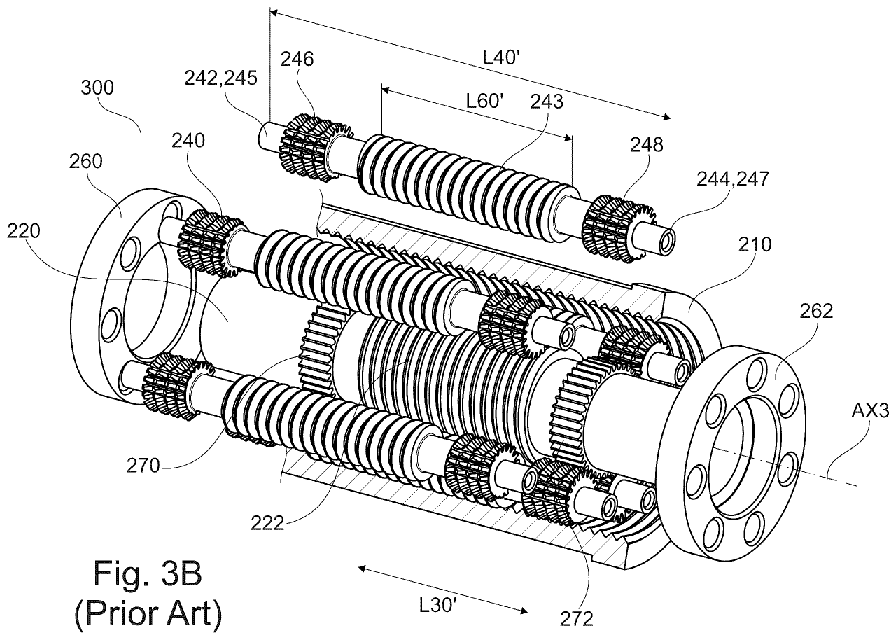

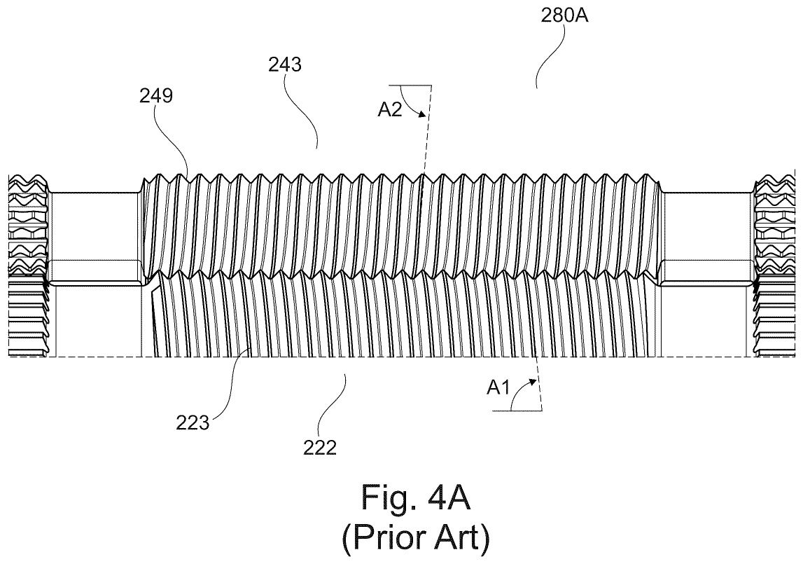

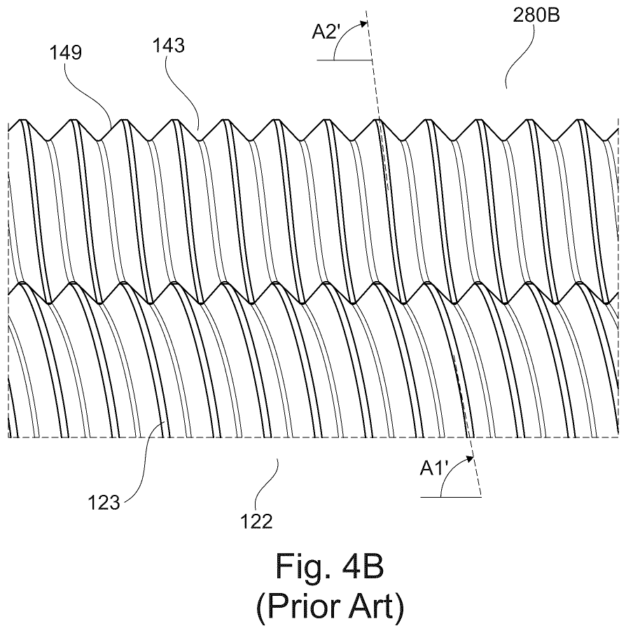

FIG. 1 shows a cross-sectional view of an example embodiment of a planetary roller screw arrangement 100. FIG. 2 shows a perspective view of a known prior art planetary roller screw arrangement 200. FIG. 3A shows a perspective view of a known prior art planetary roller screw arrangement 300. FIG. 3B shows an exploded perspective view of the planetary roller screw arrangement 300 of FIG. 3A. FIG. 4A shows a front view of a first helical thread pair 280A. FIG. 4B shows a front view of a second helical thread pair 280B. The following should be read in light of FIGS. 1 through 4B.

Turning to FIG. 2, the prior art planetary roller screw arrangement 200 includes threaded planets 140 (hereafter referred to as planets 140), a threaded spindle 120, and a threaded nut 110. As known in the art of such planetary roller screw arrangements, the planets 140 include a threaded portion 143 that engages with a threaded portion 122 of the threaded spindle 120 and an internal threaded portion 118 of the threaded nut 110 to convert an input rotary motion to output linear motion about an axis AX1. As shown, the threaded portion 143 of the planets 140 is continuous or non-segmented such that a helical thread continuously winds throughout a length of the threaded portion 143.

A first end 142 of the planets 140 includes a first journal 145 and a first gear 146 that is axially adjacent to the first journal 145. It could be stated that the first gear 146 is arranged axially inwardly of the first journal 145. A second end 144 of the planets 140 includes a second journal 147 and a second gear 148 that is axially adjacent to the second journal 147. It could be stated that the second gear 148 is arranged axially inwardly of the second journal 147.

The planetary roller screw arrangement 200 further includes a first planet ring 160 that is axially fixed or retained to a first end 112 of a bore 116 of the threaded nut 110 and a second planet ring 162 that is axially fixed or retained to a second end 114 of the bore 116 of the threaded nut 110. The first planet ring 160 includes first cylindrical bores 164 that rotatably receive the first journals 145 of the planets 140. The second planet ring 162 includes second cylindrical bores 166 that rotatably receive the second journals 147 of the planets 140. It could be stated that the first and second cylindrical bores 164, 166 serve as plain bearings for the respective first and second journals 145, 147; therefore, the planets 140 are supported by the first and second journals 145, 147. The first and second planet rings 160, 162, can rotate relative to the threaded nut 110 about the axis AX1.

The planetary roller screw arrangement 200 further includes a first gear ring 150 that is rotationally and axially fixed to the first end 112 of the bore 116 of the threaded nut 110 and a second gear ring 152 that is rotationally and axially fixed to the second end 114 of the bore 116 of the threaded nut 110. The first and second gear rings 150, 152 include respective first and second internal gear teeth 154, 156. The first gear 146 of each of the planets 140 rotatably engages the first internal gear teeth 154 and the second gear 148 of each of the planets 140 rotatably engages the second internal gear teeth 156 as the planets 140 roll around the threaded spindle 120. Thus, each one of the planets rotate about an axis AX2 as each one moves circumferentially about the threaded spindle 120.

An overall length of the threaded nut 110 defines a longitudinal length L10, while the internal threaded portion 118 spans longitudinally through the bore 116 of the threaded nut 110 and defines a longitudinal length L20. A span of the threaded portion 122 of the threaded spindle 120 defines a longitudinal length L30. An overall length of the planets 140 is defined by a longitudinal length L40; and, a span of the threaded portion 143 of the planets 140 is defined by a longitudinal length L60.

From FIG. 2 it can be easily observed that the longitudinal length L30 which defines the threaded portion 122 of the threaded spindle 120 is greater than: i) the longitudinal length L10 of the threaded nut 110, ii) the longitudinal length L20 of the internal threaded portion 118 of the threaded nut 10, iii) the longitudinal length L40 of the planets 140, and iv) a longitudinal length L60 of the span of the threaded portion 143 of the planets 140. Since the longitudinal length of the threaded portion 122 of the threaded spindle 120 is greater than the longitudinal length L10 of the threaded nut 110, the threaded portion 122 is continuously outside of the threaded nut 110 throughout use of the planetary roller screw arrangement 200.

The planetary roller screw arrangement 200 can convert rotary motion to linear motion via two different inputs. In a first conversion scenario, the threaded nut 110 is rotated in either a first direction R1 or a second direction R2, which, in turn, causes the threaded spindle 120 to move along the axis AX1 in a first direction D1 or a second direction D2. In a second conversion scenario, the threaded spindle 120 is rotated in either the first direction R1 or the second direction R2, which, in turn, causes the threaded nut to move along the axis AX1 in the first direction D1 or the second direction D2. No relative linear motion occurs between the threaded nut 110 and the planets 140, or, stated otherwise, the threaded nut 110 and planets 140 move linearly in unison relative to the threaded spindle 120 when the second conversion scenario is utilized.

Turning to FIGS. 3A and 3B. the prior art planetary roller screw arrangement 300, also known as an inverted planetary roller screw arrangement, includes threaded planets 240 (hereafter referred to as planets 240), a threaded spindle 220, a threaded nut 210, a first planet ring 260, and a second planet ring 262. The planets 240 are axially retained to the threaded spindle 220 via the first and second planet rings 260, 262. The first and second planet rings 260, 262 rotatably receive and support a respective first journal 245 and a second journal 247 of the planets 240. The first journal 245 is arranged at a first end 242 of the planets 240 and the second journal 247 is arranged at a second end 244 of the planets 240. The first and second planet rings 260, 262 can rotate relative to the threaded spindle 220 while being axially retained to the threaded spindle 220.

The planetary roller screw arrangement 300 can convert rotary motion to linear motion via two different inputs. In a first conversion scenario, the threaded nut 210 is rotated in either the first direction R1 or the second direction R2, which, in turn, causes the threaded spindle 220 to traverse within the threaded nut 210 along the axis AX3 in the first direction D1 or the second direction D2. In a second conversion scenario, the threaded spindle 220 is rotated in either the first direction R1 or the second direction R2, which, in turn, causes the threaded nut 210 to move along the axis AX3 in the first direction D1 or the second direction D2. No relative linear displacement occurs between the threaded spindle 220 and the planets 240, or stated otherwise, the threaded spindle 220 and planets 240 move linearly in unison relative to the threaded nut 210 during the first conversion scenario.

The planets 240 include a continuous and non-segmented threaded portion 243 that engages with both a threaded portion 222 of the threaded spindle 220 and an internal threaded portion 218 of the threaded nut 210. An overall length of the planets 240 defines a longitudinal length L40′. A span of the threaded portion 243 of the planets 240 is defined by a longitudinal length L60′; a span of the threaded portion 222 of the threaded spindle 220 defines a longitudinal length L30′; the internal threaded portion 218 defines a longitudinal length L20′; and an overall length of the threaded nut 210 defines a longitudinal length L10′. The longitudinal length L60′ is proximate to the longitudinal length L30′, and the longitudinal length L20′ is larger than the both the longitudinal length L60′ and the longitudinal length L30′.

Two different thread arrangements that facilitate both the relative linear displacement and the “no relative linear displacement” characteristics between the threaded components of the planetary roller screw arrangements 200, 300 will now be described.

Turning to FIG. 4A, a first helical thread pair 280A is shown that is representative of the threaded interface between the threaded portion 243 of the planets 240 and the threaded portion 222 of the threaded spindle 220 of the planetary roller screw arrangement 300 of FIGS. 3A and 3B. The threaded portion 222 of the threaded spindle 220 includes a helical thread 223 defined by a positive helix angle A1 that corresponds to a right-handed thread. The threaded portion 243 of the planets 240 includes a helical thread 249 defined by a negative helix angle A2 that corresponds to a left-handed thread. It could also be stated that the helical directions of the threaded portion 222 of the threaded spindle 220 and the threaded portion 243 of the planets 240 are opposite to each other. In this instance, no relative linear displacement occurs between the threaded spindle 220 and the planets 240 when either one of them are rotated relative to the other. Such an “opposite” helical relationship between the threaded spindle 220 and the planets 240 is typically utilized within inverted planetary roller screw arrangements, such as that shown in FIGS. 3A and 3B. This opposite helical relationship could also be achieved by applying a right-handed thread to the planets 240 and a left-handed thread to the threaded spindle 220.

An opposite helical relationship is also utilized within the planetary roller screw arrangement of FIG. 2, particularly between the internal threaded portion 118 of the threaded nut 110 and the threaded portion 143 of the planets 140, so that no relative linear displacement occurs between threaded nut 110 and the planets 140 during rotation of one of these components relative to the other.

Turning to FIG. 4B, a second helical thread pair 280B is shown that is representative of the threaded interface between the threaded portion 143 of the planets 140 and the threaded portion 122 of the threaded spindle 120 of the planetary roller screw arrangement 200 of FIG. 2. The threaded portion 122 of the threaded spindle 120 includes a helical thread 123 defined by a positive helix angle A1′ that corresponds to a right-handed thread. The threaded portion 143 of the planets 140 includes a helical thread 149 defined by a positive helix angle A2′ that corresponds to a right-handed thread. It could also be stated that the helical directions of the threaded portion 122 of the threaded spindle 120 and the threaded portion 143 of the planets 140 are the same or are “matched”. In this instance, relative linear displacement occurs between the threaded spindle 120 and the planets 140 when either one of them are rotated relative to the other. Such a helical relationship between the threaded spindle 120 and the planets 140 is typically utilized within planetary roller screw arrangement like that shown in FIG. 2. The previously described matched helical relationship could also be achieved by applying left-handed threads to each constituent of a helical thread pair.

A matched helical relationship is also utilized within the planetary roller screw arrangement of FIGS. 3A and 3B, particularly between the internal threaded portion 218 of the threaded nut 210 and the threaded portion 243 of the planets 240, so that relative linear displacement occurs between threaded nut 210 and the planets 240 during rotation of one of these components relative to the other.

The example embodiment of the planetary roller screw arrangement 100 of FIG. 1 will now be described. Similar to the previously described prior art planetary roller screw arrangements 200, 300, threaded interfaces between components are present; however, significant and impactful differences exist between the planetary roller screw arrangement 100 of FIG. 1 and those of the prior art.

The planetary roller screw arrangement 100 includes a threaded nut 10, a threaded spindle 20, and a plurality of threaded planets 40 (hereafter referred to as planets 40). The threaded nut 10, which could also be referred to as a threaded nut tube, includes a bore 16 that extends through the threaded nut 10 such that the threaded nut is open on both a first end 12 and a second end 14. A first axial end 24 of the threaded spindle 20 is coupled with or fixed to a first end 32 of a first push rod 30A that is at least partially disposed in the bore 16. In an example embodiment, the first end 32 of the first push rod 30A is continuously disposed in the bore 16. A second end 34 of the first push rod 30A extends outside of the bore 16 from the first end 12 of the threaded nut 10. In an example embodiment, the second end 34 of the first push rod 30A is continuously outside of the bore 16 or outside of the threaded nut 10. In an example embodiment, the first push rod 30A does not have external threads. The first push rod 30A can be coupled to any further or suitable component 90A that seeks linearly displacement; or the first push rod 30A can be coupled to any further or suitable component 90B that can provide a rotational input to the planetary roller screw arrangement 100.

The planetary roller screw arrangement 100 includes an optional second push rod 30B that is fixed to a second axial end 26 of the threaded spindle 20. Similar to the previously described first push rod 30A, the second push rod 30B can be coupled to any further component that seeks linear displacement. A truncated length of the second push rod 30B is depicted in FIG. 1, however, any suitable length of the second push rod 30B can be utilized. Both the first and second push rods 30A, 30B can serve as longitudinal supports for the planets 40 during certain loading conditions. For example, in an instance of radial inward deflection of the planets 40 due to any of the various thread engagement and threaded spindle 20 locations, the first and second push rods 30A, 30B can serve as an abutment 41 or landing which limits a magnitude of the radial inward deflection.

The bore 16 includes a continuous threaded portion 18 proximate to the second end 14 of the threaded nut 10. The term “continuous” is meant to signify that the threaded portion 18 extends through the bore without interruption. The threaded portion 18 only extends partially through the bore 16, which simplifies manufacturing of the threaded nut 10. The planets 40 extend throughout (or nearly so) the length of the threaded nut 10, well beyond the threaded portion 18.

A first end 42 of each of the planets 40 includes a first journal 45 and a first gear 46 that is axially adjacent to the first journal 45. A second end 44 of each of the planets 40 includes a second journal 47 and a second gear 48 that is axially adjacent to the second journal 47. The first and second gears 46, 48 can be separate components or formed directly onto each of the first and second ends 42, 44 of the planets 40. A threaded portion 43 extends between the first and second gears 46, 48 of each of the planets 40. In an example embodiment, the threaded spindle 20 moves linearly throughout the entire threaded portion 43 of the planets 40. Stated otherwise, the threaded spindle 20 moves linearly relative to the planets 40. A first portion 72 of the threaded portion 43 remains in continuous thread engagement with the threaded portion 18 of the bore 16. A second portion 74 of the threaded portion 43 extends away from the threaded portion 18 towards the first end 12 of the threaded nut 10; no thread engagement between second portion 74 and the threaded portion 18 occurs. The first portion 72 threadedly engages the threaded spindle 20 (or the threaded portion 22 thereof) when the threaded spindle 20 is at a longitudinal position that axially overlaps with the threaded portion 18. The second portion 74 threadedly engages the threaded spindle 20 (or the threaded portion 22 thereof) when the threaded spindle 20 is at a longitudinal position that does not axially overlap with the threaded portion 18. The term “axial overlap” is meant to signify when two features (or a portion thereof) are radially adjacent to each other. For example, in FIG. 1, a longitudinal length L7 is representative of an axial overlap between the threaded spindle 20 and the threaded portion 18 of the threaded nut 10 when the threaded spindle 20 is positioned, as shown, within a left side of the bore 16 of the threaded nut 10 (threaded spindle is drawn with solid lines). When the threaded spindle 20 is positioned within a right side of the bore 16 of the threaded nut 10 (threaded spindle drawn with broken lines), as shown, no axial overlap is present between the threaded spindle 20 and the threaded portion 18 of the threaded nut 10.

The planetary roller screw arrangement 100 further includes a first planet ring 60 that is axially fixed to the first end 12 of a bore 16 of the threaded nut 10 and a second planet ring 62 that is axially fixed to a second end 14 of the bore 16 of the threaded nut 10. The first planet ring 60 includes first cylindrical bores 64 that rotatably receive the first journals 45 of the planets 40. The second planet ring 62 includes second cylindrical bores 66 that rotatably receive the second journals 47 of the planets 40 (the journals rotate within the bores). It could be stated that the first and second cylindrical bores 64, 66 serve as plain bearings for the respective first and second journals 45, 47; therefore, the planets 40 are supported via the first and second journals 45, 47. The first and second planet rings 60, 62, can rotate relative to the threaded nut 10 about an axis AX4. In an example embodiment, the first and second planet rings 60, 62 are axially fixed to the threaded nut 10 via a snap ring. Thus, the planets 40 are axially retained to the threaded nut 10 via the first and second planet rings 60, 62. As shown in FIG. 1, a span between the first and second planet rings 60, 62 can define the overall longitudinal distance L1 of the threaded nut 10.

The planetary roller screw arrangement 100 further includes a first internal gear 50 formed via a first gear ring 51 that is rotationally and axially fixed to the first end 12 of the bore 16 of the threaded nut 10 and a second internal gear 52 formed via a second gear ring 53 that is rotationally and axially fixed to the second end 14 of the bore 16 of the threaded nut 10. The first and second internal gears 50, 52 include respective first and internal gear teeth (not shown, but like that shown in FIG. 2). The first gear 46 of each of the planets 40 rotatably engages the first internal gear teeth, and the second gear 48 of each of the planets 40 rotatably engages the second internal gear teeth as the planets 40 roll around the threaded spindle 20. Thus, each one of the planets rotate about an axis AX2 as each one moves circumferentially about the threaded spindle 20 about the axis AX4. The first and second gear rings 51, 53 are separate components that are fixed to the first and second ends 12, 14 of the threaded nut 10 via a press-fit or any other suitable attachment methods. The first and second internal gears 50, 52 (or the teeth thereof) can be machined or formed directly onto the bore 16 of the threaded nut 10. The previously described first and second bearing journals 45, 47 extend axially outwardly from the respective first and second planet gears 46, 48.

The planets 40 are disposed radially between the threaded spindle 20 and the bore 16 of the threaded nut 10 such that they are arranged circumferentially around the threaded spindle 20. A threaded portion 43 of the planets 40 is threadably engaged with both the threaded portion 18 of the bore 16 and a threaded portion 22 of the threaded spindle 20. In the example embodiment shown in FIG. 1, the threaded portion 22 of the threaded spindle 20 extends from the first axial end 24 to the second axial end 26 of the threaded spindle 20. However, in other example embodiments, each end of the threaded portion 22 stops short of the first and second axial ends 24, 26 of the threaded spindle 20. In an example embodiment, an entirety of the threaded spindle 20 (and threaded portion thereof) is continuously disposed within the threaded nut 10 regardless of the relative position between the threaded nut 10 and the threaded spindle 20.

In an example embodiment, rotary motion is converted to linear motion via rotation of the threaded nut 10 which then induces rotation of the planets 40 around the threaded spindle 20 which, in turn induces linear motion of the threaded spindle 20 and first and second push rods 30A, 30B. The threaded nut 10 can be rotated in either direction R1, R2 to achieve linear motion of the threaded spindle 20 in either a first direction D1 or a second direction D2, such that the first and second push rods 30A, 30B have a telescoping action relative to the respective first and second ends 12, 14 of the threaded nut 10. FIG. 1 shows an example further linear position of the threaded spindle 20 (drawn with broken lines) that is possible when the threaded nut 10 is rotated and the threaded spindle 20 is linearly displaced to the right; hereafter, this position is referred to as the “displaced position”. In this displaced position of the threaded spindle 20, the threaded spindle 20 lies outside of the threaded portion 18 of the threaded nut 10 such that no overlap exists between the threaded spindle 20 and the threaded portion 18. Stated otherwise, an axial gap G1 or space between a second axial end 26 of the threaded spindle 20 (or an end of the threaded portion 22) is present within the threaded nut 10 while the threaded spindle 20 is in the displaced position. No portion of the threaded spindle 20 (or the threaded portion 22 thereof) resides within the axial gap G1.

As shown in FIG. 1, the bore 16 of the threaded nut 10 is only partially threaded (via the threaded portion 18) which simplifies manufacturing costs. The threaded portion 18 only extends to a partial depth of the bore 16. Between the threaded portion 18 and the first end 12 of the threaded nut 10, the bore 16 can include a non-threaded portion 19 with a diameter proximate to an outer diameter of a planet circle D3 defined by the planets 40 so as to provide guidance.

In an example embodiment, rotary motion is converted to linear motion via rotation of the first or second push rods 30A, 30B and/or the threaded spindle 20, which then induces rotation of the planets 40 and causes linear motion of the threaded nut 10.

The threaded nut 10 defines an overall longitudinal length L1; the threaded portion 18 of the threaded nut 10 defines a longitudinal length L2; and the non-threaded portion 19 of the threaded nut 10 defines a longitudinal length L8. A span of the threaded portion 22 of the threaded spindle 20 defines a longitudinal length L3. An overall length of the planets 40 defines a longitudinal length L4; and a span of the threaded portion 43 of the planets 40 is defined by a longitudinal length L5. A hypothetical linear distance traversed by the threaded spindle 20 in the displaced position within the threaded nut 10 is defined by a longitudinal length L6 which is greater than the longitudinal length L3 of the span of the threaded portion 22 of the threaded spindle 20. The longitudinal length L1 of the threaded nut 10 can be identical or proximate to the overall longitudinal length LA of the planets 40; however, in further example embodiments, L1 can be greater than or less than L4. The longitudinal length L2 of the threaded portion 18 (of the bore 16 of the threaded nut 10) can be identical or proximate to the longitudinal length L3 of the threaded portion 22 of the threaded spindle 20; however, in further example embodiments, L2 can be greater than or less than L3. The longitudinal length L8 of the non-threaded portion 19 of the bore 16 of the threaded nut 10 can be greater than the longitudinal length L2 of the threaded portion 18 and the longitudinal length of the threaded portion L3 of the threaded spindle.

The terminology “longitudinal length” in the context of this disclosure is meant to signify a linear length or dimension of a feature or component along its lengthwise direction or along a primary or main axis. Further, the longitudinal length of a threaded portion is meant to signify a linear length that encompasses a first end of a helical thread and a second end of the helical thread that defines or forms the threaded portion. Thus, the longitudinal length of a threaded portion encompasses an overall length of a formed or machined thread, from a beginning of the thread to an end of the thread and not merely a segment of the spiral thread between its two ends. In a further aspect, the threaded portions described herein can included multi-start threads as known in the field of planetary roller screw arrangements.

In an example embodiment, the threaded nut 10 can be constructed of two nut parts 10A, 10B together with an optional preload washer 80 that applies a preload to the previously described threaded interfaces. In a further aspect, the threaded nut 10 can be constructed of additional components not described herein or shown in the figures. The two nut parts 10A, 10B could be assembled with the planets 40, preloaded axially outwardly via the preload washer 80, and then fastened together via laser welding or any suitable means to maintain the preloaded assembly. In a further aspect, a preload device (adjustable or non-adjustable) could be incorporated with the nut to achieve a desired preload.

In an example embodiment, the first and second gears 46, 48 applied to the first and second ends of each of the planets 40 can serve as axial stops S1, S2 during relative movement between the threaded spindle 20 and the threaded nut 10. In an example embodiment, a maximum linear movement of the threaded spindle 20 in the first direction D1 within the threaded nut 10 is defined or limited by an axial abutment that occurs between the first axial end 24 of the threaded spindle 20 and the first gear 46; correspondingly, a maximum linear movement of the threaded spindle 20 in the second direction D2 within the threaded nut 10 is defined or limited by an axial abutment that occurs between the second axial end 26 of the threaded spindle 20 and the second gear 48. Thus, the longitudinal length L5 of the threaded portion 43 of the planets 40 can determine or define an axial travel pathway of the threaded spindle 20 within the threaded nut 10. Stated otherwise, the longitudinal length L5 of the threaded portion 43 can define a relative axial movement limit between the threaded spindle 20 and the threaded nut 10.

In an example embodiment, an outer circumference of the first and second gears 46, 48 could include a threaded interface so that the threaded spindle 20 could threadedly engage the first and second gears 46, 48 and move linearly beyond the first and second gears. Such a dual interface (gear+thread) is shown in FIGS. 3A and 3B.

The two previously described helical thread pairs 280A, 280B of FIGS. 4A and 4B (“opposite” and “matched”) also apply to the planetary roller screw arrangement 100. A threaded interface that includes the threaded portion 18 of the threaded nut 10 and the threaded portion 43 of the planets 40 is defined by an opposite helical arrangement so that no relative linear displacement occurs between the threaded nut 10 and the planets 40 during relative rotation between these components. It could also be stated that one of the threaded portion 18 of the threaded nut 10 or the threaded portion 43 of the planets 40 has a left-handed thread, and a remaining one of these two threaded portions 18, 43 has a right-handed thread. Further, the threaded interface that includes the threaded portion 43 of the planets 40 and the threaded portion 22 of the threaded spindle 20 is defined by a matched helical relationship so that relative linear displacement occurs between the threaded spindle and the planets 40.

The relative sizes of some of the previously described features of the planetary roller screw arrangement 100 should be noted. A ratio of the longitudinal length L1 (of the threaded nut 10) to the longitudinal length L2 of the threaded portion 18 (of the threaded nut 10) can be greater than at least 1.5; in further example embodiments this ratio is at least 2, 3, 4, or 5. A ratio of the longitudinal length L1 (of the threaded nut 10) to the longitudinal length L3 of the threaded portion 22 (of the threaded spindle 20) can also be greater than at least 1.5, and, in further example embodiments, greater than at least 2, 3, 4, or 5. Further, a ratio of a longitudinal length L5 of the threaded portion 43 (of the planets 40) to the longitudinal length L3 of the threaded portion 22 (of the threaded spindle 20) can also be greater than at least 1.5, and, in further example embodiments, greater than at least 2, 3, 4, or 5. For all of the discussed relative size ratios above, any suitable ratio can be achieved, such as those greater than 5.

While example embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A planetary roller screw arrangement configured to convert rotary motion to linear motion, comprising:
a threaded nut having:
a first longitudinal length; and
a first threaded portion, and
a first end of the first threaded portion and a second end of the first threaded portion define a second longitudinal length;
a threaded spindle having a second threaded portion, and a first end of the second threaded portion and a second end of the second threaded portion define a third longitudinal length, the threaded spindle disposed within the threaded nut;
a plurality of threaded planets:
arranged radially between the threaded spindle and the threaded nut;
having a third threaded portion configured to be threadedly engaged with the first threaded portion, and a first end of the third threaded portion and a second end of the third threaded portion define a fourth longitudinal length; and
rotation of one of the threaded nut or the threaded spindle causes relative linear displacement between the threaded spindle and the plurality of threaded planets via the first threaded portion, the second threaded portion, and the third threaded portion; and
the fourth longitudinal length is greater than the third longitudinal length.

2. The planetary roller screw arrangement of claim 1, wherein the fourth longitudinal length is greater than the second longitudinal length.

3. The planetary roller screw arrangement of claim 1, wherein a ratio of the fourth longitudinal length to the the third longitudinal length is at least 1.5.

4. The planetary roller screw arrangement of claim 1, wherein first longitudinal length is greater than the third longitudinal length.

5. The planetary roller screw arrangement of claim 1, wherein the third threaded portion threadedly engages the second threaded portion.

6. The planetary roller screw arrangement of claim 1, wherein a first end of the threaded spindle is coupled to a first push rod, and a second end of the threaded spindle is coupled to a second push rod.

7. The planetary roller screw arrangement of claim 1, wherein a first end of the threaded spindle is coupled to a push rod, and the push rod is configured as an abutment that limits radial deflection of the plurality of threaded planets.

8. The planetary roller screw arrangement of claim 1, wherein the threaded spindle is configured to move to a linear position where the third longitudinal length does not overlap with the second longitudinal length in an axial direction.

9. The planetary roller screw arrangement of claim 1, further comprising:
a first internal gear arranged at a first end of the threaded nut; and
a second internal gear arranged at a second end of the threaded nut; and
the first internal gear and the second internal gear having internal gear teeth engaging with the plurality of threaded planets.

10. The planetary roller screw arrangement of claim 9, wherein each one of the plurality of threaded planets includes:
a first planet gear arranged at a first end, the first planet gear configured to engage the first internal gear; and
a second planet gear arranged at a second end, the second planet gear configured to engage the second internal gear.

11. The planetary roller screw arrangement of claim 1, further comprising:
a first planet ring arranged at a first end of the threaded nut, the first planet ring configured to: i) rotatably support a first end of each one of the threaded planets, and ii) rotate relative to the threaded nut; and
a second planet ring arranged at a second end of the threaded nut, the second planet ring configured to: i) rotatably support a second end of each one of the threaded planets, and ii) rotate relative to the threaded nut.

12. A planetary roller screw arrangement configured to convert rotary motion to linear motion, comprising:
a threaded nut comprising:
a first planet ring fixed to a first end; and
a second planet ring fixed to a second end, the first planet ring and the second planet ring defining a first longitudinal length of the threaded nut; and
a bore having a first threaded portion, the first threaded portion spanning a second longitudinal length;
a threaded spindle having a second threaded portion spanning a third longitudinal length;
a plurality of threaded planets rotatably supported by the first planet ring and the second planet ring, the plurality of threaded planets:
arranged radially between the threaded spindle and the threaded nut; and
having a third threaded portion configured to be threadedly engaged with the first threaded portion, the third threaded portion spanning a fourth longitudinal length; and
the first longitudinal length is greater than the third longitudinal length.

13. The planetary roller screw arrangement of claim 12 wherein the fourth longitudinal length is greater than the third longitudinal length.

14. The planetary roller screw arrangement of claim 12, wherein a first end of the plurality of threaded planets defines a first axial travel stop for the threaded spindle and a second end of the plurality of threaded planets defines a second axial travel stop for the threaded spindle.

15. The planetary roller screw arrangement of claim 12, wherein the threaded nut further comprises:
a first internal gear arranged at the first end of the threaded nut, the first internal gear configured to engage a first gear arranged on each one of the plurality of threaded planets; and
a second internal gear arranged at the second end of the threaded nut, the second internal gear configured to engage a second gear arranged on each one of the plurality of threaded planets.

16. A planetary roller screw arrangement configured to convert rotary motion to linear motion, comprising:
a threaded nut having a bore, the bore comprising:
a first threaded portion arranged at a first end of the bore, a first end of the first threaded portion and a second end of the first threaded portion defining a first longitudinal length; and
a second non-threaded portion arranged between the first threaded portion and a second end of the bore in an axial direction, a first end of the second non-threaded portion and a second end of the non-threaded portion defining a second longitudinal length;
a plurality of threaded planets having:
a first planet end rotatably supported by the first end of the bore;
a second planet end rotatably supported by the second end of the bore; and
a second threaded portion: i) configured to threadedly engage the first threaded portion, and ii) extending across the second non-threaded portion in an axial direction toward the second planet end; and
a threaded spindle having a third threaded portion configured to threadedly engage the plurality of threaded planets so as to move the threaded spindle linearly relative to the plurality of threaded planets; and
a first end of the third threaded portion and a second end of the threaded portion define a third longitudinal length that is less than the second longitudinal length.

17. The planetary roller screw arrangement of claim 16, wherein rotation of one of the threaded nut or the threaded spindle causes relative linear displacement between the threaded spindle and the plurality of threaded planets.

18. The planetary roller screw arrangement of claim 16, wherein the third threaded portion is configured to threadedly engage the first threaded portion.

19. The planetary roller screw arrangement of claim 16, wherein the second longitudinal length is greater than the first longitudinal length.

20. The planetary roller screw arrangement of claim 16, wherein the second threaded portion extends continuously with a constant outer diameter.
